(19) United States
(12) Patent Application Publication
(10) Pub. No.: US 2016/0165642 A1
(43) Pub. Date: Jun. 9, 2016

(54) Latency Reduction for User Equipment with Bursty Interactive Traffic

(71) Applicant: Nokia Corporation, Espoo (FI)

(72) Inventors: Petteri Lundén, Espoo (FI); Elena Virtej, Espoo (FI); Ilkka Keskitalo, Oulu (FI)

(21) Appl. No.: 14/562,006

(22) Filed: Dec. 5, 2014

(51) Int. Cl. H04W 76/02; H04W 72/04

(52) U.S. Cl. CPC H04W 76/02; H04W 72/04

(57) ABSTRACT

In accordance with the exemplary embodiments there is at least a method and apparatus configured to establish, by a user equipment, a radio resource control connected state of a communication link; receive an indication instructing the user equipment to maintain at least one element of the radio resource control connected state of the communication link; and maintaining indefinitely the at least one element of the radio resource control connected state, wherein the at least one element is to be maintained after a data transfer using the radio resource control connected state of the communication link. Further there is establishing a radio resource control connected state of a communication link with a user equipment; receiving data on the communication link from the user equipment; and sending a message instructing the user equipment to maintain indefinitely at least one element of the radio resource control connected state of the communication link.

### TECHNICAL FIELD

The teachings in accordance with the exemplary embodiments of this invention relate generally to reducing latency for user equipment in an LTE system and, more specifically, relate to reducing latency caused by RRC connection establishment procedures in the LTE system.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Certain abbreviations that may be found in the description and/or in the Figures are herewith defined as follows:
ACK acknowledgement
BSR buffer status report
CSI channel state information
CQI channel quality indication
DRX discontinuous reception
eNB base station
HOF handover failure
LTE long term evolution
MDT minimization of drive tests
MO mobile originated
MT mobile terminated
NAS non-access stratum
NW network
PDCCH physical downlink control channel
PUCCH physical uplink control channel
RACH random access channel
RLF radio link failure
RNTI radio network temporary identifier
RA-RNTI random access radio network temporary identifier
RRC radio resource control
RRH remote radio head
SMS short message service
SR scheduling request
TA timing advance
TAT time alignment timer
TMSI temporary mobile subscriber identity
TAU tracking area update
T-CRNTI temporary cell radio network temporary identifier
UE user equipment
UL uplink

Connection setup for minimal data transmission requirements such as data traffic bursts has become an issue for wireless communication especially for LTE due to the required control signaling overhead. Whenever a connection is setup a series of communications between user equipment and the network are required. Though the time required for these communications may be considered small the resulting latency caused by the connection setup can be quite evident to a user of the user equipment. The exemplary embodiments of the invention work to address at least these issues regarding latency of data traffic caused by connection setup procedures.

### SUMMARY

In an exemplary aspect of the invention, there is a method comprising: establishing, by a user equipment, a radio resource control connected state of a communication link to a network node of a communication network in a cell served by the network node; receiving an indication instructing the user equipment to maintain at least one element of the radio resource control connected state of the communication link; and in response to the indication, maintaining, by the user equipment, indefinitely the at least one element of the radio resource control connected state of the communication link, wherein the at least one element of the radio resource control connected state is to be maintained after a data transfer using the radio resource control connected state of the communication link.

In another exemplary aspect of the invention, there is an apparatus comprising: at least one processor; and at least one memory including computer program code, where the at least one memory and the computer program code are configured, with the at least one processor, to cause the apparatus to at least: establish, with a apparatus, a radio resource control connected state of a communication link to a network node of a communication network in a cell served by the network node; receive an indication instructing the apparatus to maintain at least one element of the radio resource control connected state of the communication link; and in response to the indication, maintaining with the apparatus, indefinitely the at least one element of the radio resource control connected state of the communication link, wherein the at least one element of the radio resource control connected state is to be maintained after a data transfer using the radio resource control connected state of the communication link.

In another exemplary aspect of the invention, there is an apparatus comprising: at least one processor; and at least one memory including computer program code, where the at least one memory and the computer program code are configured, with the at least one processor, to cause the apparatus to at least: establish in a communication network a radio resource control connected state of a communication link with a user equipment in a cell served by the apparatus; receive data on the uplink from the user equipment; and send a message comprising a radio resource control information element to the user equipment instructing the user equipment to maintain at least one element of the radio resource control connected state of the communication link after the data transfer is complete.

### BRIEF DESCRIPTION OF THE DRAWINGS

The foregoing and other aspects of embodiments of this invention are made more evident in the following Detailed Description, when read in conjunction with the attached Drawing Figures, wherein:

FIG. 1 shows a present LTE RRC Connection Establishment procedure;

FIG. 2 shows a simplified block diagram of devices configured to perform operations in accordance with the exemplary embodiments of the invention;

FIG. 3 shows signaling load flow for call set-up in accordance with the exemplary embodiments;

FIG. 4 shows connections states and transitions between them; and

FIGS. 5A and 5B each show a method in accordance with the exemplary embodiments which may be performed by an apparatus.

### DETAILED DESCRIPTION

In this invention, we propose at least a radio resource control (RRC) connection maintenance method to reduce latency caused by RRC connection establishment procedures in a system, such as an LTE system.

The exemplary embodiments of the invention relate to reducing latency in an LTE system. Of course, as such latency could be understood in a various forms such as for example latency in getting access to a cell, latency in getting the data offloaded, and latency in (re-) establishing a connection after a failure event etc. Further, one crucial aspect which is covered by the exemplary embodiments of the invention includes decreasing the latency of a UE transitioning from IDLE state to CONNECTED state. This is important, because this latency is often directly observed by the user as an additional delay in the user initiated (e.g., mobile originated) data.

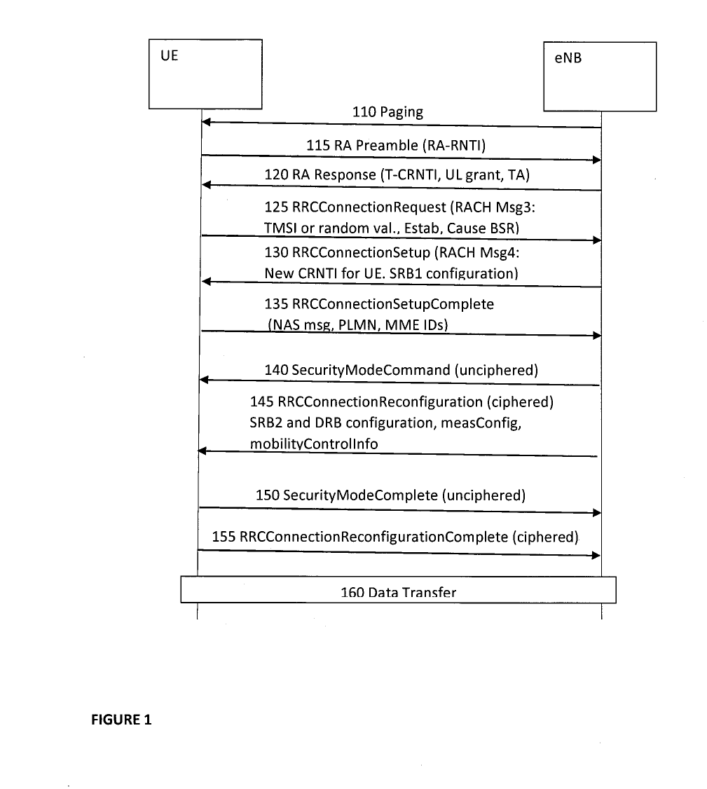

Presently in LTE the RRC Connection establishment procedure, even though streamline as such, is still consuming time as RRC messages are exchanged back and forth. The call setup takes around 80 ms of time (depending of course somewhat on NW load, backhaul latency, UE channel quality etc.). RRC connection establishment can be used to make a transition from an RRC Idle mode (IDLE) to an RRC Connected mode. An RRC Connected mode is required before a device such as a UE can transfer any application data, or complete any signaling procedures. Thus, every time a UE is released to IDLE and, after, requires a data transmission the UE needs to perform the connection establishment procedure to get connected again. This not only consumes UE battery but also takes some time and causes signaling overhead, such as in the air-interface and in the network. A signaling flow diagram of the present RRC connection setup procedure is shown in FIG. 1.

FIG. 1 shows a current LTE RRC Connection Establishment procedure. As shown in step 110 the eNB is paging the UE. At step 115 the UE responds with a random access (RA) preamble. At step 120 the eNB responds to the RA and as indicated this response can include a temporary cell radio network temporary identifier (T-CRNTI), and UL grant, and/or a timing advance (TA). At step 125 the UE send an RRCConnectionRequest to the eNB. This request can include a random access channel message (RACH Msg 3) which can include a temporary mobile subscriber identity (TMSI) or a random value. At step 130 the eNB send an RRCConnectionSetup message to the UE. At step 135 the UE responds with an RRCConnectionSetupComplete message. Then at step 140 a SecurityModeCommand is sent unciphered by the eNB to the UE. At step 145 an RRCConnectionReconfiguration is sent by the eNB to the UE. Then at step 150 the UE sends a SecurityModeComplete message unciphered to the eNB. At step 155 the UE send an RRCConnectionReconfigurationComplete message ciphered to the eNB. Then at step 160 there is a Data Transfer between the UE and the eNB.

As similarly stated above, if a UE that is released to an IDLE state requires a data transmission it must follow the RRC connection establishment procedure to get connected again. The RRC connection establishment procedure is initiated by the UE but can be triggered by either the UE or the network. For example, an RRC connection establishment is triggered if an end-user starts an application to browse the internet or to send an email for example. Similarly, the RRC connection establishment is triggered if a UE moves into a new Tracking Area and has to complete a tracking area update signaling procedure. The network triggers the RRC connection establishment procedure by sending a Paging message such as the paging message 110 of FIG. 1. In addition, this connection would be required for delivery of an incoming SMS or notification of an incoming voice call for example.

It is understood that if the UE performs bursty and/or interactive traffic such as for web browsing where new data is initiated by the user (e.g. interacting with the browser) followed by some longer reading times without any traffic it may be considered good from UE power consumption point of view to release UE's connection in between data bursts. However, this causes overhead from signaling (and thus power consumption) point of view and additional delay. In practice this means that in this common use case, the user will always notice the additional delay (e.g., approx. 80 ms) before the intended link is opened and the page loaded and rendered and thus visible to the user.

On the other hand, if the network would keep UE connected between the traffic bursts the latency would be shortened but this would increase the UE power consumption significantly, even if using DRX (which also would increase the latency). The UE may be configured [by RRC/MAC] with a connected mode DRX functionality that allows the UE to stop monitoring PDCCH during some period of time. Besides connected mode DRX, the UE may use Discontinuous Reception (DRX) in idle mode as well in order to reduce power consumption. One Paging Occasion (PO) is a subframe where there may be P-RNTI transmitted on PDCCH addressing the paging message. One Paging Frame (PF) is one Radio Frame, which may contain one or multiple Paging Occasion(s). When DRX is used the UE needs only to monitor one PO per DRX cycle. This is according to 3GPP TS 36.304 V12.2.0 (September 2014). The main purpose of Paging is for the network (NW) to reach a UE in idle state (e.g. RRC_IDLE). Of course paging could be used for UEs in RRC_CONNECTED mode. In FIG. 1, the Paging is used by NW to reach the UE in the RRC_IDLE state.

The exemplary embodiments of the invention provide a compromise solution that combines the best parts of both of these approaches (e.g., connected mode with short latency and idle mode with low power consumption).

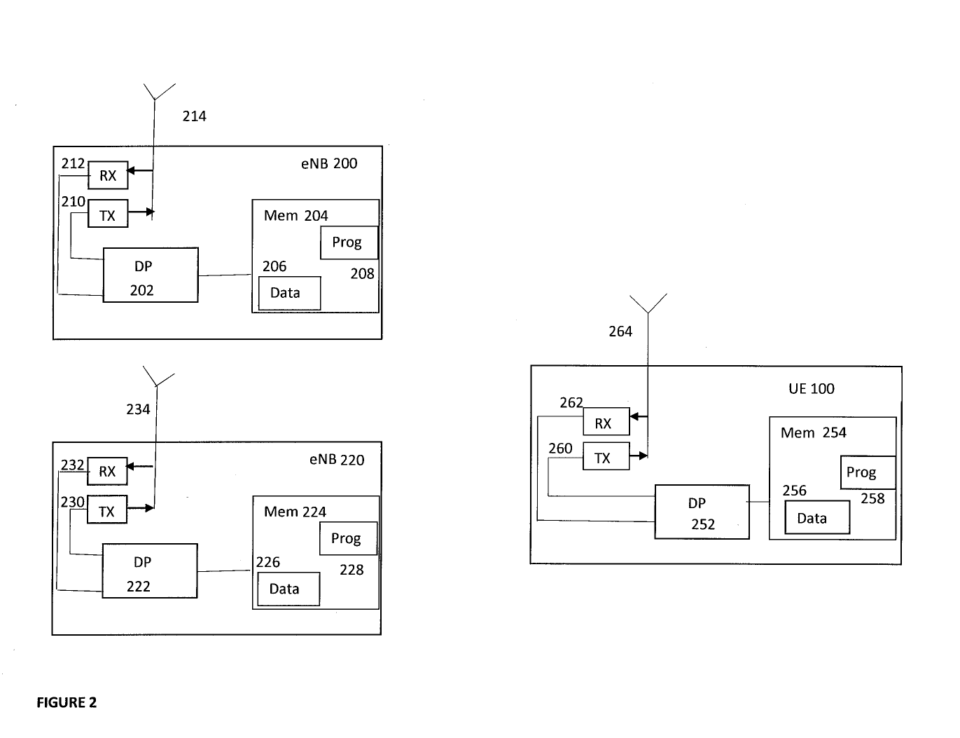

Before describing the exemplary embodiments of the invention in further detail reference is now made to FIG. 2. FIG. 2 illustrates a simplified block diagram of base stations such as an eNB 200 and an eNB 220, and a user device, such as a UE 100, suitable for use in practicing the exemplary embodiments of this invention. In FIG. 2 an apparatus, such as the eNB 200 and the eNB 220, is adapted for communication with other apparatuses having wireless communication capability, such as the UE 100.

The eNB 200 includes processing means such as at least one data processor (DP) 202, storing means such as at least one computer-readable memory (MEM) 204 storing data 206 and at least one computer program (PROG) 208 or other set of executable instructions, communicating means such as a transmitter TX 210 and a receiver RX 212 for bidirectional wireless communications with the UE 100 via an antenna 214.

The eNB 220 includes processing means such as at least one data processor (DP) 222, storing means such as at least one computer-readable memory (MEM) 224 storing data 226 and at least one computer program (PROG) 228 or other set of executable instructions, communicating means such as a transmitter TX 230 and a receiver RX 232 for bidirectional wireless communications with the UE 100 via an antenna 234.

The UE 100 includes processing means such as at least one data processor (DP) 252, storing means such as at least one computer-readable memory (MEM) 254 storing data 256 and at least one computer program (PROG) 258 or other set of executable instructions, communicating means such as a transmitter TX 260 and a receiver RX 262 for bidirectional wireless communications with the eNB 200 or the eNB 220 via one or more antennas 264. The UE 100, e.g. if capable of dual connectivity, may have multiple transmitters TX and receivers RX to enable simultaneous communication with eNB 200 and eNB 220. In addition, it is noted that although FIG. 2 may only illustrate one transmitter TX and one receiver RX in the eNB 200, the eNB 220, or the UE 100 this is non-limiting in accordance with the exemplary embodiments and these devices can each be configured to simultaneously support multiple RX and/or TX communications or chains with multiple devices. In accordance with the exemplary embodiments the data 206, 226, and/or 256 may include data required to implement a method and operate an apparatus in accordance with the exemplary embodiments of the invention.

At least one of the PROGs 208 in the eNB 200 is assumed to include a set of program instructions that, when executed by the associated DP 202, enable the device to operate in accordance with the exemplary embodiment to implement a specific intermediate state to keep particular elements of a radio resource control connection of the UE 100 on hold without releasing, and cause the UE 100 to autonomously transition to IDLE mode when changing cells, as detailed herein in accordance with the exemplary embodiments. In these regards the exemplary embodiments of this invention may be implemented at least in part by computer software stored on the MEM 204, which is executable by the DP 202 of the eNB 200, or by hardware, or by a combination of tangibly stored software and hardware (and tangibly stored firmware).

Similarly, at least one of the PROGs 228 in the eNB 220 is assumed to include a set of program instructions that, when executed by the associated DP 222, enable the device to operate in accordance with the exemplary embodiments of this invention, as detailed above. In these regards the exemplary embodiments of this invention may be implemented at least in part by computer software stored on the MEM 224, which is executable by the DP 222 of the eNB 220, or by hardware, or by a combination of tangibly stored software and hardware (and tangibly stored firmware).

Similarly, at least one of the PROGs 258 in the UE 100 is assumed to include a set of program instructions that, when executed by the associated DP 252, enable the device to operate in accordance with the exemplary embodiments of this invention, as detailed above. In these regards the exemplary embodiments of this invention may be implemented at least in part by computer software stored on the MEM 254, which is executable by the DP 252 of the UE 100, or by hardware, or by a combination of tangibly stored software and hardware (and tangibly stored firmware). Electronic devices implementing these aspects of the invention need not be the entire devices as depicted at FIG. 2 or may be one or more components of same such as the above described tangibly stored software, hardware, firmware and DP, or a system on a chip SOC or an application specific integrated circuit ASIC.

In general, the various embodiments of the UE 100 can include, but are not limited to personal portable digital devices having wireless communication capabilities, including but not limited to cellular telephones, navigation devices, laptop/palmtop/tablet computers, smart watches, wearables, digital cameras and music devices, and Internet appliances.

Various embodiments of the computer readable MEM 204, 224, and 254 include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DP 202, 222, and 252 include but are not limited to general purpose computers, special purpose computers, microprocessors, digital signal processors (DSPs) and multi-core processors.

While various exemplary embodiments have been described above it should be appreciated that the practice of the invention is not limited to the exemplary embodiments shown and discussed here. Various modifications and adaptations to the foregoing exemplary embodiments of this invention may become apparent to those skilled in the relevant arts in view of the foregoing description.

Further, some of the various features of the above non-limiting embodiments may be used to advantage without the corresponding use of other described features.

The foregoing description should therefore be considered as merely illustrative of the principles, teachings and exemplary embodiments of this invention, and not in limitation thereof.

The exemplary embodiments of the invention provide for signaling overhead reduction to reduce a latency time which can be caused by connection setup such as due to small and infrequent transmissions. In accordance with the exemplary embodiments of the invention there is, instead of sending new RRC message for continuing connection, a UE can resume a previously established connection immediately after random access to the same cell. This saves time required for the RRC signaling to establish a new connection and reduces delay. Further, in accordance with the exemplary embodiments UE may use a previously established connection and resume it by using a random access to a cell identified in a list provided to the UE, and for other cells UE may go to IDLE mode before establishing another connection.

The exemplary embodiments of the invention provide a new RRC connection state (which herein may be referred to as a pseudo connected state) that enables fast reconnection, but does not have the overhead of handovers or frequent measurements and CSI reporting. A characteristic feature of the embodiments is that in the new state a UE can still autonomously transitions to IDLE from it when there is change of cell to a cell which requires a new RRC connection. To enable this, it is proposed to have a mobility trigger to autonomously transition from the new state to IDLE mode in case of a change of cells. A change of cells may mean e.g. a handover (for example UE autonomous handover) or a cell reselection or cell selection, or other such procedure which results UE to change serving cell. This change of cells may be performed by the UE autonomously without explicit command from the network. It may be based on cell or carrier or RAT specific signal quality criteria, thresholds and/or priorities configured by the network.

In some sense, this pseudo connected state (or pseudo idle state, i.e. the new proposed state) maintains some elements of a previously connected state and the pseudo connected state acts as a conditional (possibly indefinitely delayed) connection release. As a non-limiting example in accordance with the embodiments these elements may be any elements which were established in the RRC connection procedure as shown in FIG. 1. When releasing UE's connection, the NW could signal the UE that it should delay at least some element of the RRC connection release in order to enter a new intermediate state, such as a state where at least a part of an RRC connection is maintained. In this regard there is disclosed a new indication in the RRCConnectionRelease IE or a new IE could be defined for this purpose, for instance a message indication such as an RRCConnectionConditionalRelease or RRCConnectionPseudo Release indication, though other names or IEs could be used as well.

In this exemplary pseudo connected state the UE (and the NW) refrain from releasing UE's connection entirely and immediately, but instead put elements of the connection on hold so that it can be resumed if there is new data. The UE shall monitor a cell change condition that triggers the UE autonomous release of the connection and transition to IDLE mode.

The main novel aspects of the invention include the pseudo connected state characterized by 1) UE's connection kept on hold without releasing, and 2) UE autonomously transitioning to IDLE mode when changing cell. In the pseudo connected state:

The UE can resume connection without connection (re-)establishment and related RRC signaling, and there is not the overhead of CSI reporting etc.;

Connection is released conditionally: UE releases it autonomously, but only if the cell changes. The UE power saving starts immediately as UE stops sending CSI and can measure with more relaxed requirements;

Connection can be released autonomously after a certain period of time (e.g., 5 minutes). This limits the overhead on the network (as it does not need to wait UE's TAU or connection establishment in another cell to release the old connection); and

Connection need only be released from connected state during change to a cell not supported by the network. A list of cells\provided to the UE identifies the cells with which a change to does not require releasing the connection.

Regarding the list of cells as mentioned above, in the pseudo connected state as above, but additionally the UE is signaled a list of cells to which it can change in the new state without releasing the connection. In accordance with the exemplary embodiments of the invention a list of cells could be provided to a UE. This list of cells can comprise cells served by the same eNB (using RRH or ideal backhaul connection/fronthaul)—as this would allow easy configuration with maintained elements of a connection including but not limited to the bearers and the security keys (for example, in effect performing an intra-cell HO in the NW side after UE has already changed the cell). The cells in the list can be configured with PUCCH resources (especially SR) and C-RNTI for the UE (per cell configuration indicated in the signaling, or the same configuration is used in all the listed cells). In some embodiments, this could be delayed until UE performs random access to the cell.

In accordance with the exemplary embodiments a network device or node, such as a UE, can also autonomously transition to the new RRC connection state based on expiration of an inactivity timer which is started in response to an elapsed period of time where there has been no activity on a communication link with the UE. The duration of the inactivity timer can start for example after activity by a device has ended on a communication link. The settings of this timer may be pre-programmed or manually programmed for the device and/or received in signalling by the device. The settings of this timer may be set by the network or may be dynamic such as based on a usage history of the device. Such a usage history may identify how often the device has used a communication link for example. It is noted that any operations which as described herein are performed by or with a UE are non-limiting, and in accordance with the exemplary embodiments these operations can be performed with any network device or network node such as but not limited to a base station, an access point, and a mobile device.

In practice implementing the proposed solution means that eNB/NW maintains UE's connection and related resources or elements (bearers etc., though in some cases it could be possible to also release the reserved PUCCH resources except SR until UE returns) even after UE transitions to the new state. This new state is active until the UE resumes connection in the current cell or changes cell.

Benefits of the invention include that, in the new state, the UE power consumption is lower than in the RRC connected mode, because UE only needs to monitor for paging in DL and also UE doesn't send CSI reports. On the other hand, the latency of initiating mobile originated traffic is shorter than in the idle mode because connection re-establishment is avoided. Also there is no overhead of mobility, as the UE autonomously releases the connection in the event of a handover or cell change to a cell which is not on the list as described above (if such list of cells is configured). The reasoning here is that releasing UE to idle mode after traffic activity ends (for the moment, e.g. due to user reading a web page etc.) makes sense if UE is moving and would require HO signaling, but if this is not the case, it would be better to maintain connection. The thinking is that most of the time the UE would be returning to connected state and only rarely changing the cell. The network could configure this state instead of releasing UE's connection, such as depending on UE's traffic profile, mobility state and/or the cell where the UE is connected to (e.g. web browsing traffic for a stationary UE in an indoor cell).

When UE is kept in the new state (connection maintained, but UE is measuring less frequently and or reporting measurements or CSI less frequently or not at all), it doesn't need to re-establish connection when resuming communication with the same eNB (MO traffic). Instead random access to re-sync UL and sending BSR is enough, or directly sending a scheduling request if UL sync is still valid; TAT could be running still in the new state for this purpose, or a new value for it could be configured for the UE when transitioning to the new state. If cell sizes are small, there may not be need for TA and in this case the TAT could be set to infinite. In another embodiment, in case UE's TA has expires (or changes) UE autonomously releases the connection.

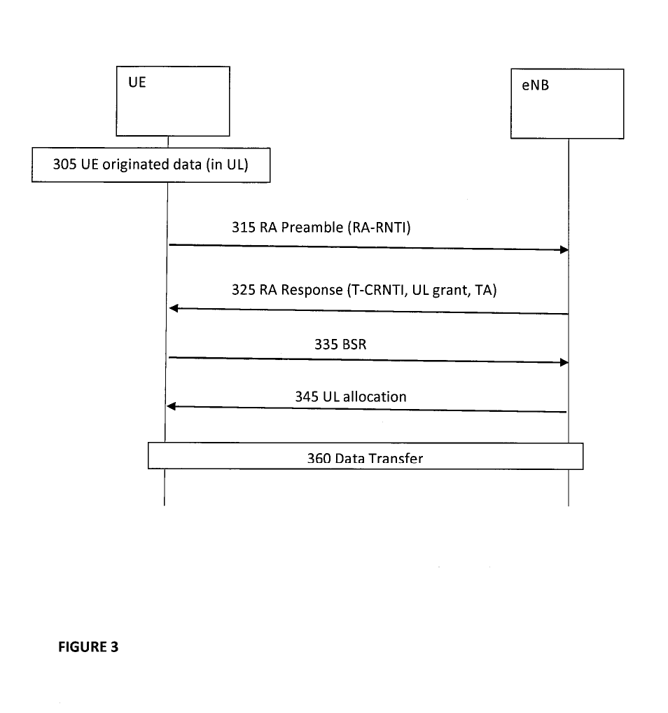

The new procedure is illustrated in FIG. 3 below. This solution significantly reduces the latency compared to the present LTE configuration as seen by comparing FIG. 1 and FIG. 3 (time consuming RRC signaling is avoided). If an UL TA is valid, the connection can be resumed even faster as the random access can be avoided. As an example, as shown in FIG. 3 at step 305 there is UE originating data to transfer in the uplink (UL). Then at step 315 the UE sends a random access (RA) preamble (e.g. RA-RNTI, indication for L2/L3 message size) to the eNB for the data. At step 325 the UE receives an RA response from the eNB which can include a T-CRNTI, UL grant (for e.g. L2/L3 message), and/or TA. At step 335 the UE sends a buffer status report regarding the data in UE's buffer to the eNB. At step 345 the eNB provides the UE with an UL allocation. Then the UE at step 360 performs the data transfer. As can be seen the exemplary operations as shown in FIG. 3 require much less operations and time than the RRC connection establishment procedure as shown with FIG. 1.

In an optional embodiment, to reduce the overhead on the NW, to keep the connection there could be a timer associated to the conditional connection release. Then after the timer expires the connection is released regardless of the cell change. This limits the overhead on the network as the NW does not need to wait for the UE's tracking area update or connection establishment in another cell to release the old connection.

Further, it is noted that the exemplary embodiments of the invention are not limited to use for only an uplink. In accordance with the exemplary embodiments of the invention the new RRC connection state can be implemented in any type of communication link that accepts an RRC connection. For example, the new RRC connection state may be implemented in a downlink, an uplink, and even a device to device communication link.

In addition, in accordance with the exemplary embodiments of the invention the new RRC connection state can be implemented by and with any network node or device. Such network nodes or devices including user equipment, base stations, relays, and/or an access points. Further, the exemplary embodiments of the invention can be used in any network type including LTE networks.

Another optional embodiment: NW may include information on which cells it can reselect without causing the autonomous release to IDLE. These could be e.g. remote radio heads (RRH) controlled by the same eNB, but appearing as different eNBs to the UE. In this case the NW would need to configure UE some SR resources to all of these so that it can autonomously reselect cell. This would cause some minor overhead, but on the other hand this type of deployment could be rather common, for example in office buildings or small buildings.

In accordance with the exemplary embodiments a configuration of the new pseudo connected state may include one or more of (or a combination of at least one or more):
In one embodiment, NW may instruct UE to transition to the new state (e.g. instead of releasing UE's connection) and configures the UE with appropriate measurements and carrier/cell priorities (for changing cell) by RRC signaling. Other connection parameters can be (re-)configured as well such as TAT;
In another embodiment the NW may configure UE also a timer for transitioning to IDLE mode regardless of the cell change; and/or
In another embodiment the NW may configure UE also with a list of cells (controlled by same eNB) where UE autonomously changes without releasing the connection. The NW reserves in the other listed cells PUCCH resources and C-RNTI for the UE. In some embodiments, these steps could be delayed until UE performs random access to the cell.

In accordance with the exemplary embodiments operations in the new (pseudo connected) state can include one or more of (or a combination of at least one or more):
MT traffic: UE monitors for paging;
MO traffic: UE sends SR to resume connection (and transition back to RRC connected). If UL sync has been lost (for example TAT expired), UE first performs random access to resynchronize;
UE measures according to the configuration received when entering the state. It does not report measurements or CSI/CQI; and/or
When the cell changes (optionally to a cell not listed in the configuration received when entering the state), UE autonomously transitions to IDLE state and releases the connection.

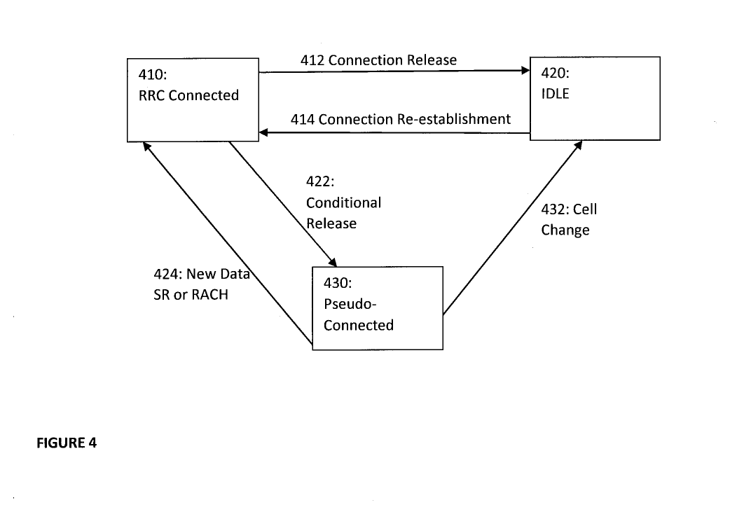

FIG. 4 illustrates how the new (pseudo-connected) state fits in the current framework and the reasons/triggers for transitions between the states. As shown in FIG. 4 there is a RRC Connected state 410 and an RRC Idle state 420. As shown with arrow 412 the RRC Connected state 410 can be released to the RRC Idle state 420, and the RRC Connected state 410 can be re-stablished from the Idle state 420 as shown with arrow 414. In accordance with the exemplary embodiments of the invention as shown with arrow 424 the new Pseudo-connected state 430 may use the RRC Connected state 410 to exchange new data. The arrow 424 also shows that the new Pseudo-connected state 430 may use an SR or a RACH to setup to exchange the new data. Further, as shown with arrow 422 the Pseudo-connected state 430 may be released under specific conditions, as are similarly described herein. As shown with arrow 432 the Pseudo-connected state 430 may be conditionally used for a cell change operation by a UE.

The network may instruct UE to transition to the new pseudo-connected state in a situation where it would typically release UE's connection. This could be for example, when the UE's traffic activity ends or enters a longer silent period. To trigger this transition there may be a timer in the network measuring inactivity of the UE, and after certain period of inactivity (no traffic), the UE is signaled to move to pseudo-connected state. In some example embodiments, the UE may be configured to move to pseudo-connected state autonomously after a certain period of inactivity (i.e. a period of no traffic).

The exemplary embodiments of the invention work to reduce the latency significantly for a UE that has intermittent or bursty interactive traffic (such as web browsing). Keeping the UE in the connected mode for the whole session can consume too much power, so it would be good to release UE's connection in between the traffic bursts. To avoid latency (and signaling overhead) from reconnecting, we propose releasing UE to a new state as described in the present invention report. This can lead to substantial benefits as long as the UE hasn't moved too much in between the bursts (which is a likely use case).

As can be seen a benefit of the exemplary embodiments of the invention is that it reduces the delay when the new connection is established to the same cell (or optionally a cell controlled by the same eNB). Then at the same time the operations in accordance with the exemplary embodiments of the invention allow a UE to save power compared to being in RRC CONNECTED mode all the time.

The connection could be released to the pseudo-connected state with explicit signaling from the NW to UE, or after a configured release timer expires (in this case the UE is configured with the timer and the pseudo-connected state parameters beforehand). In the RLF/HOF reporting for MDT, the loss of connection in case UE moves out of the original cell would not be counted as RLF.

In another embodiment, PDCCH monitoring could be maintained when the UE is in the new mode but UE has not changed the cell. Only when UE moves to a new cell, the state becomes basically the idle mode. In this alternative the NW would first attempt to reach UE with PDCCH order, but if that is not responded by the UE, the NW would continue with paging.

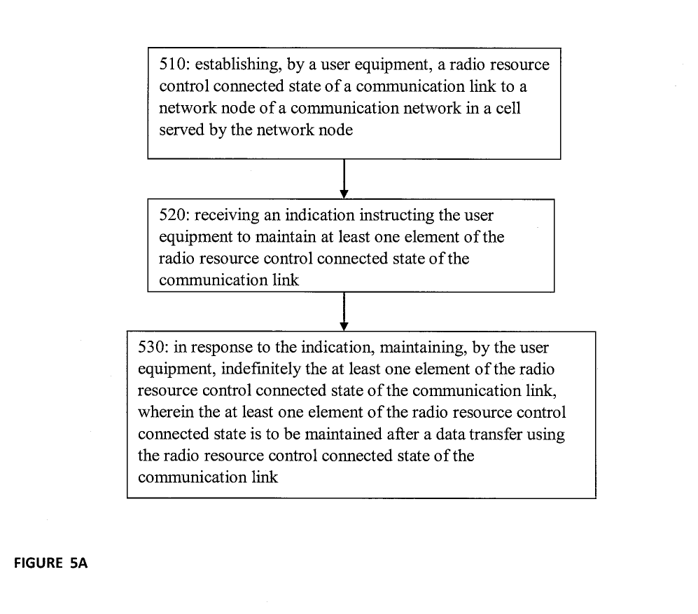

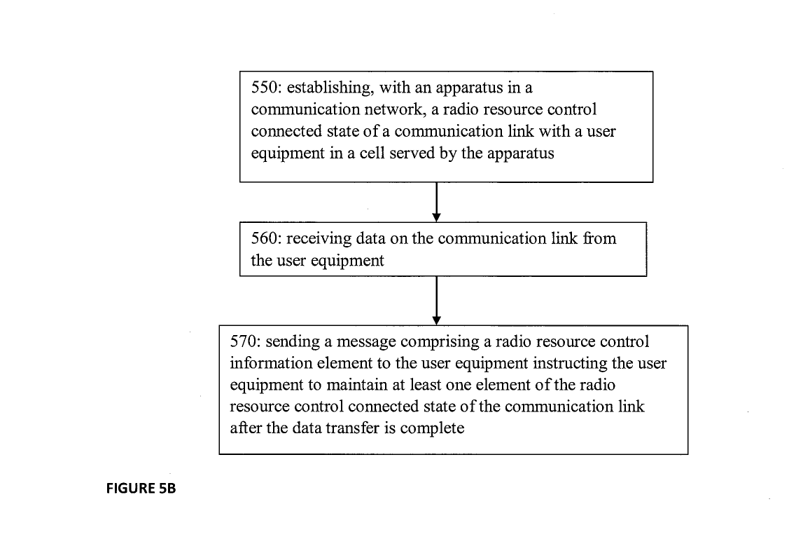

FIG. 5A illustrates operations which may be performed by a network device such as, but not limited to, UE (e.g., the UE 100 as in FIG. 2). As shown in step 510 of FIG. 5A, there is establishing, by a user equipment, a radio resource control connected state of a communication link to a network node of a communication network in a cell served by the network node. At step 520 there is receiving an indication instructing the user equipment to maintain at least one element of the radio resource control connected state of the communication link. Then at step 530 there is in response to the indication, maintaining by the user equipment, indefinitely the at least one element of the radio resource control connected state of the communication link, wherein the at least one element of the radio resource control connected state is to be maintained after a data transfer using the radio resource control connected state of the communication link

In accordance with the exemplary embodiments as described in the paragraph above, the indication comprises one of a message from the communication network, and an expiration of an inactivity timer at the user equipment.

In accordance with the exemplary embodiments as described in the paragraphs above, at least one element of the radio resource control connected state is maintained indefinitely until at least one of explicit signaling from the communication network instructing the user equipment to release the at least one element of the resource control connected state, an expiration of a timer, and a movement of the user equipment to a cell not served by the network node.

In accordance with the exemplary embodiments as described in the paragraphs above, the maintained at least one element of the radio resource control connected state comprises at least one bearer and security key of the radio resource control connected state.

In accordance with the exemplary embodiments as described in the paragraphs above, the message from the communication network further comprises instructions for the user equipment relating to at least one of measurement configurations, carrier and/or cell change priorities, and timing advance timer information.

In accordance with the exemplary embodiments as described in the paragraphs above, while the user equipment is maintaining the at least one element of the connected state of the communication link after the data transfer the user equipment does not send channel state information to the network node, and one of does not report measurements and reports measurements less frequently to the network node.

In accordance with the exemplary embodiments as described in the paragraphs above, for a case that another data transfer is required, there is sending a scheduling request over the communication link using the maintained at least one element of the radio resource control connected state to the network node; and based on the scheduling request, resuming the radio resource control connected state of the communication link and transferring the another data over the communication link to the network node.

In accordance with the exemplary embodiments as described in the paragraphs above, there is at least one of re-synchronizing the communication link and sending a buffer status report to the network node over the communication link prior to sending the scheduling request.

In accordance with the exemplary embodiments as described in the paragraphs above, there is receiving from the communication network a list of cells which are supported by the network node and do not require a change of the maintained at least one element of the radio resource control connected state.

In accordance with the exemplary embodiments as described in the paragraphs above, there is detecting, by the user equipment, a cell change condition of the user equipment to a new cell of the communication network; in response to the detecting, there is determining whether the new cell is on the list of cells which do not require a change of the maintained at least one element of the radio resource control connected state; and based on the determining that the new cell is on the list of cells, there is selecting the new cell with the maintained at least one element of the radio resource control connected state, else based on the determining that the new cell is not on the list of cells, there is autonomously transitioning the communication link to an idle state and performing a connection operation to the new cell.

In accordance with the exemplary embodiments as described in the paragraphs above, there is upon an expiration of the timer autonomously transitioning the communication link to an idle state and releasing the maintained at least one element of the radio resource control connected state communication link.

In accordance with an exemplary embodiment of the invention as described above there is an apparatus comprising: means for establishing, by a user equipment [UE100 as in FIG. 2] of a communication network, a radio resource control connected state of a communication link to a network node [eNB 200 or 220 as in FIG. 2] in a cell served by the network node. There is means for receiving [DP252] an indication instructing the user equipment [UE100] to maintain at least one element of the radio resource control connected state of the communication link. Means in response to the indication, for maintaining [DP252], by the user equipment [UE100], indefinitely the at least one element of the radio resource control connected state of the communication link, wherein the at least one element of the radio resource control connected state is to be maintained after a data transfer using the radio resource control connected state of the communication link.

In the exemplary aspect of the invention according to the paragraph above, wherein the means for establishing, receiving, and maintaining comprises a non-transitory computer readable medium [MEM 204, 224, and/or 254] encoded with a computer program [PROG 208, 228, and/or 258]; and/or [Data 206, 226, and 256] executable by at least one processor [DP 202, 222, and/or 252].

FIG. 5B illustrates operations which may be performed by a network device such as, but not limited to, a network access node (e.g., the eNB 200 or eNB 220 as in FIG. 2). As shown in step 550 of FIG. 5B, there is establishing, with an apparatus in a communication network, a radio resource control connected state of a communication link with a user equipment in a cell served by the apparatus. At step 560 there is receiving data on the communication link from the user equipment. Then at step 570 there is sending a message comprising a radio resource control information element to the user equipment instructing the user equipment to maintain indefinitely at least one element of the radio resource control connected state of the communication link after the data transfer is complete.

In accordance with the exemplary embodiments as described in the paragraph above, the at least one element of the radio resource control connected state is to be maintained indefinitely until at least one of explicit signaling from the communication network instructing the user equipment to release the resource control connected state, an expiration of a timer, and a movement of the user equipment to a cell not served by the apparatus.

In accordance with the exemplary embodiments as described in the paragraphs above, the maintaining comprises maintaining at least one bearer and security key of the radio resource control connected state.

In accordance with the exemplary embodiments as described in the paragraphs above, the message to the user equipment further comprises instructions for the user equipment relating to at least one of measurement configurations, carrier and/or cell change priorities, and timing advance timer information.

In accordance with the exemplary embodiments as described in the paragraphs above, while the user equipment is maintaining the at least one element of the connected state of the communication link after the data transfer the apparatus does not receive channel state information from the user equipment, and one of does not receive measurements and receives measurements less frequently from the user equipment.

In accordance with the exemplary embodiments as described in the paragraphs above there is sending to the user equipment a list of cells which are supported by the access node and do not require a change of the at least one element of the connected state of the communication link

In accordance with an exemplary embodiment of the invention as described above there is an apparatus comprising: means for establishing in a communication network a radio resource control connected state of a communication link with a user equipment [UE100 as in FIG. 2] in a cell served by the apparatus. Means for receiving data on the communication link from the user equipment. Means for sending a message comprising a radio resource control information element to the user equipment instructing the user equipment to maintain indefinitely at least one element of the radio resource control connected state of the communication link after the data transfer is complete.

In the exemplary aspect of the invention according to the paragraph above, wherein the means for establishing, receiving and sending comprises a non-transitory computer readable medium [MEM 204, 224, and/or 254] encoded with a computer program [PROG 208, 228, and/or 258]; and/or [Data 206, 226, and 256] executable by at least one processor [DP 202, 222, and/or 252].

The apparatus maybe, include or be associated with at least one software application, module, unit or entity configured as arithmetic operation, or as a computer program or portions thereof (including an added or updated software routine), executed by at least one operation processor, unit or module. Computer programs, also called program products or simply programs, including software routines, applets and/or macros, may be stored in any apparatus-readable data storage medium. A computer program product may comprise one or more computer-executable components which, when the program is run, are configured to carry out embodiments described above by means of FIGS. 5A and/or 5B. Additionally, software routines may be downloaded into the apparatus.

The apparatus, such as an access node or user device, or a corresponding component, may be configured as a computer or a microprocessor, such as single-chip computer element, or as a chipset, including or being coupled to a memory for providing storage capacity used for software or arithmetic operation(s) and at least one operation processor for executing the software or arithmetic operation(s).

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the preferred embodiments of this invention could be used to advantage without the corresponding use of other features. As such, the foregoing description should be considered as merely illustrative of the principles of the invention, and not in limitation thereof.

What is claimed is:

1. A method comprising:
establishing, by a user equipment, a radio resource control connected state of a communication link to a network node of a communication network in a cell served by the network node;
receiving an indication instructing the user equipment to maintain at least one element of the radio resource control connected state of the communication link; and
in response to the indication, maintaining, by the user equipment, indefinitely the at least one element of the radio resource control connected state of the communication link, wherein the at least one element of the radio resource control connected state is to be maintained after a data transfer using the radio resource control connected state of the communication link.

2. The method of claim 1, wherein the indication comprises one of a message from the communication network, and an expiration of an inactivity timer at the user equipment.

3. The method of claim 1, wherein the at least one element of the radio resource control connected state is maintained indefinitely until at least one of explicit signaling from the communication network instructing the user equipment to release the at least one element of the resource control connected state, an expiration of a timer, and a movement of the user equipment to a cell not served by the network node.

4. An apparatus comprising:
at least one processor; and
at least one memory including computer program code, where the at least one memory and the computer program code are configured, with the at least one processor, to cause the apparatus to at least:
establish a radio resource control connected state of a communication link to a network node of a communication network in a cell served by the network node;
receive an indication instructing the apparatus to maintain at least one element of the radio resource control connected state of the communication link; and
in response to the indication, maintaining with the apparatus, indefinitely the at least one element of the radio resource control connected state of the communication link, wherein the at least one element of the radio resource control connected state is to be maintained after a data transfer using the radio resource control connected state of the communication link.

5. The apparatus of claim 4, wherein the indication comprises one of a message from the communication network, and an expiration of an inactivity timer at the apparatus

6. The apparatus of claim 4, wherein the at least one element of the radio resource control connected state is maintained indefinitely until at least one of explicit signaling from the communication network instructing the apparatus to release the at least one element of the resource control connected state, an expiration of a timer, and a movement of the apparatus to a cell not served by the network node.

7. The apparatus of claim 4, wherein the maintained at least one element of the radio resource control connected state comprises at least one bearer and security key of the radio resource control connected state.

8. The apparatus of claim 5, wherein the message from the communication network further comprises instructions for the apparatus relating to at least one of measurement configurations, carrier and/or cell change priorities, and timing advance timer information.

9. The apparatus of claim 4, wherein while the apparatus is maintaining the at least one element of the connected state of the communication link the apparatus does not send channel state information to the network node, and one of does not report measurements and reports measurements less frequently to the network node.

10. The apparatus of claim 4, wherein for a case that a data transfer is required, the method comprising:
sending a scheduling request over the communication link using the maintained at least one element of the radio resource control connected state to the network node; and
based on the scheduling request, resuming the radio resource control connected state of the communication link and transferring the another data over the communication link to the network node.

11. The apparatus of claim 10, wherein the at least one memory including the computer program code is configured with the at least one processor to cause the apparatus to at least one of re-synchronize the communication link and send a buffer status report to the network node over the communication link prior to sending the scheduling request.

12. The apparatus of claim 4, comprising receiving from the communication network a list of cells which are supported by the network node and do not require a change of the maintained at least one element of the radio resource control connected state.

13. The apparatus of claim 12, wherein the at least one memory including the computer program code is configured with the at least one processor to cause the apparatus to:
detect a cell change condition of the apparatus to a new cell of the communication network;
in response to the detecting, determine whether the new cell is on the list of cells which do not require a change of the maintained at least one element of the radio resource control connected state; and
based on the determining that the new cell is on the list of cells, select the new cell with the maintained at least one element of the radio resource control connected state, else
based on the determining that the new cell is not on the list of cells, autonomously transition the communication link to an idle state and performing a connection operation to the new cell.

14. The apparatus of claim 4, wherein the at least one memory including the computer program code is configured with the at least one processor to cause the apparatus to: upon an expiration of the timer autonomously transitioning the communication link to an idle state and releasing the maintained at least one element of the radio resource control connected state communication link.

15. An apparatus comprising:
at least one processor; and
at least one memory including computer program code, where the at least one memory and the computer program code are configured, with the at least one processor, to cause the apparatus to at least:
establish in a communication network a radio resource control connected state of a communication link with a user equipment in a cell served by the apparatus;
receive data on the communication link from the user equipment; and
send a message comprising a radio resource control information element to the user equipment instructing the user equipment to maintain at least one element of the radio resource control connected state of the communication link after the data reception is complete.

16. The apparatus of claim 15, wherein the at least one element of the radio resource control connected state is to be maintained indefinitely until at least one of explicit signaling from the communication network instructing the user equipment to release the at least one element of the resource control connected state, an expiration of a timer, and a movement of the user equipment to a cell not served by the apparatus.

17. The apparatus of claim 15, wherein the maintaining comprises maintaining at least one bearer and security key of the radio resource control connected state.

18. The apparatus of claim 15, wherein the message to the user equipment further comprises instructions for the user equipment relating to at least one of measurement configurations, carrier and/or cell change priorities, and timing advance timer information.

19. The apparatus of claim 15, wherein while the user equipment is maintaining the at least one element of the connected state of the communication link the apparatus does not receive channel state information from the user equipment, and one of does not receive measurements and receives measurements less frequently from the user equipment.

20. The apparatus of claim 15, wherein the at least one memory including the computer program code is configured with the at least one processor to cause the apparatus to send to the user equipment a list of cells which are supported by the apparatus and do not require a change of the maintained at least one element of the connected state of the link.
